(19) United States
(12) Patent Application Publication
(10) Pub. No.: US 2007/0045421 A1
(43) Pub. Date: Mar. 1, 2007

(54) [BARCODE DISPLAY DEVICE HAVING DATA PROCESSING ABILITY AND ITS OPERATION PROCEDURE]

(75) Inventor: Kuo-Nien Liu, TAIPEI (TW)

Correspondence Address: MARSON TECHNOLOGY CO., LTD., P.O. BOX 108-00403, TAIPEI, TW

(73) Assignee: MARSON TECHNOLOGY CO., LTD., Hsin-Tien City, Taipei Hsien. (TW)

(21) Appl. No.: 11/162,092

(22) Filed: Aug. 29, 2005

(51) Int. Cl. G06K 7/10

(52) U.S. Cl. 235/462.01

(57) ABSTRACT

A barcode display device is disclosed to include a connection interface connectable to a host system, a microprocessor for receiving data from the host system through the connection interface and converting the received data into a barcode signal, a display screen, and a display drive control module for driving the display screen to display the barcode signal outputted from the microprocessor so that the user can scan the displayed barcode with a barcode reader and store the barcode data in a memory inside the barcode reader.

### BACKGROUND OF THE INVENTION

1. Field of the Invention

The present invention relates to display means and more specifically, to a barcode display device, which converts hot system data into a corresponding barcode signal for display on a display screen.

2. Description of the Related Art

Following fast development of information technology, non-store retailing has become more and more popular. Under systematic planning of marketing experts, many non-store retailing systems have been disclosed and have appeared on the market. Among these non-store retailing systems, auto vending service or the so-called non-person vending service attracts most people to discuss. An auto vending service uses an auto vending machine to complete a transaction upon insertion of a specific transaction medium such as coin or computer readable IC card. Auto vending services are commonly employed in gas stations, launderettes, video game centers, luggage terminals, parking lots, and etc. non-store vending services are also used to sell tickets, beverage, foods, and etc.

Nowadays, auto vending machines are commonly seen in public places and street sides to sell any of a variety of products. An auto vending machine comprises a coin or banknote receiver for receiving a coin or banknote to make a transaction. The coin or banknote receiver has means to check the authenticity of the inserted coin or banknote, means to prevent backward movement of the inserted coin or banknote, means to return the inserted coin or banknote, and means to count the value of the inserted coin(s) or banknote(s). In business administration, salesmen are in charge of supplying sales items to all auto vending machines installed in different places, collecting received coins or banknotes from all auto vending machines, and repairing auto vending machines that failed. When finished all works, salesmen carry the related data back to the office for further handling. This business administration method requires salesmen to collect money from the installed auto vending machines, facing the change that a salesman may steal money from the auto vending machines. Because this business administration consumes much labor and time, it is not an efficient way, and the administration cost is high. Although an auto vending machine has means to count the total amount of the money received, it cannot eliminate human error or fraudulence, or other stealthy lawbreaking activities.

Further, in the cyber era, computerization is commonly employed to control product research and development as well as product fabrication, distribution, storage and warehousing works. Barcode recognition is quite important in these control works. A barcode pattern does not require much installation space in a product. Further, a person cannot alter a barcode. Therefore, barcodes are intensively used to mark products, facilitating business administration and inventory control and improving administration efficiency. It is important to fully utilize the advantages of barcodes in shortening operation flow, accelerating operation speed, and eliminating possible human errors in business administration.

### SUMMARY OF THE INVENTION

The present invention has been accomplished under the circumstances in view. It is one object of the present invention to provide a barcode display device, which uses a control device to receive data from a host system and to convert the data into a corresponding barcode signal for display on a display screen, so that the displayed barcode can be scanned by a barcode reader and stored in a memory of the barcode reader, eliminating the chance of altering the storage data of the host system by the user that may cause a big company loss. It is another object of the invention to provide a barcode display device, which fully utilizes the characteristic of small memory space occupation of a barcode signal by converting a big amount of host system data into barcode data for storage in a memory of a barcode reader, for enabling the storage barcode data to be further transmitted to a processing unit that is capable of returning the barcode data into the original data format.

### BRIEF DESCRIPTION OF THE DRAWINGS

FIG. 1 is a system block diagram of the present invention.

FIG. 2 is a schematic drawing showing an application example of the present invention.

FIG. 3 is a system block diagram of an alternate form of the present invention.

FIG. 4 is a schematic drawing showing the character display mode, graphic display mode and barcode display mode of the display screen of the barcode display device.

FIG. 5 is an operation flow of the present invention.

### DETAILED DESCRIPTION OF THE PREFERRED EMBODIMENT

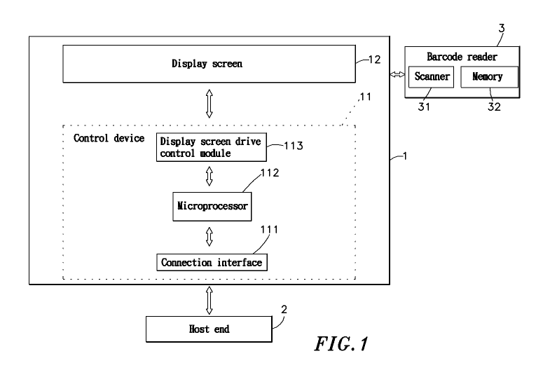

Referring to FIG. 1, a barcode display device 1 is shown comprising a control device 11 and a display screen 12. The control device 11 comprises a connection interface 111, a microprocessor 112, and a display drive control module 113.

The connection interface 111 is connected to a host system 2. When connected, the connection interface 111 obtains from the host system 2 the necessary working voltage for the barcode display device 1.

The microprocessor 112 is electrically connected to the connection interface 111 to receive data from the host system 2 and to convert (encode) received data into a barcode signal.

The display drive control module 113 is electrically connected to the microprocessor 112, and adapted to receive the barcode signal from the microprocessor 112 and to drive the display screen 12 to display the barcode signal.

The display screen 12 is electrically connected to the display drive control module 113 of the control device 11, and controlled by the display drive control module 113 to display data.

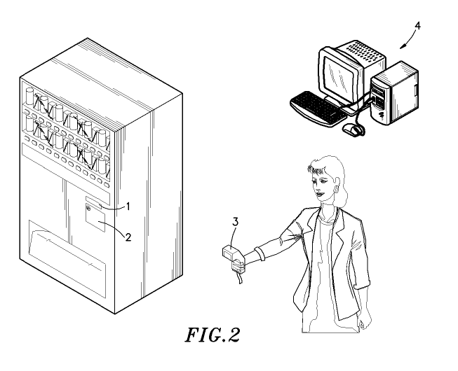

Referring to FIG. 2 and FIG. 1 again, when the user wishing to receive data from the host system 2, the host system 2 is operated to transmit the desired data through the connection interface 111 to the microprocessor 112, for enabling the microprocessor 112 to convert (encode) the data into a corresponding barcode signal and to send the barcode signal through the display drive control module 113 to the display screen 12 for display. At this time, the user can use a scanner 31 of a barcode reader 3 to scan the barcode from the display screen 12 and to store the scanned barcode data into a memory 32 of the barcode reader 3. If the user wishes to know the content of the barcode data stored in the memory 32 of the barcode reader 3, the user can use a transmission means to transmit the storage barcode data to a processing unit (for example, a personal computer) 4, that returns the barcode data into the original data format.

As indicated above, the invention uses the microprocessor 112 to convert (encode) the data of the host system 2 into a corresponding barcode signal and the display drive control module 113 to drive the display screen 12 to display the barcode signal. This design prevents the user from altering the storage data of the host system 2, and can convert the big amount of data of the host system 2 into barcode data that requires less storage space of the memory 32 of the barcode reader 3. When desired, the user can transmit storage barcode data from the memory 32 of the barcode reader 3 to the processing unit 4, enabling the processing unit 4 to return the barcode data into the original data format. This procedure is easy to perform. Because the invention eliminates the complicated transcription work as adopted in the prior art methods, the working efficiency is greatly improved, allowing the user to collect data from multiple host systems rapidly.

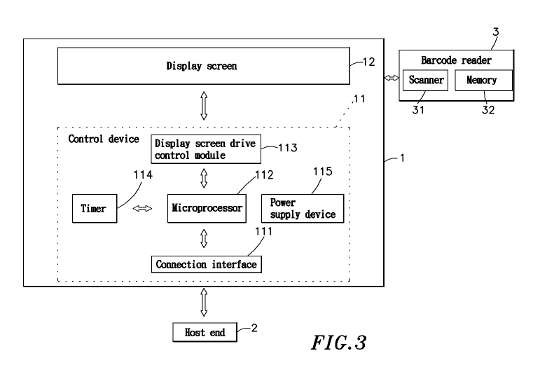

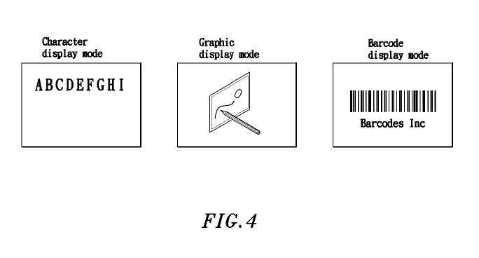

FIGS. 3 and 4 show an alternate form of the present invention. This embodiment is substantially similar to the aforesaid first embodiment with the exception of the added power supply device 115 and timer 114. The power supply device 115 provides the barcode display device 1 with the necessary working voltage. The timer 114 is adapted to measure a time interval and signals its end. When not to display a barcode, the display screen 12 provides a character display mode and a graphic display mode for displaying date, time, advertising message, and other information.

Further, the connection interface 111 of the barcode display device 1 can be a two-wire serial bus interface, MPU interface, or UART interface. The barcode signal encoded by the microprocessor 112 can be a one-dimensional, two-dimensional barcode signal or self-defined barcode signal. The one-dimensional barcode signal can be an EAN/UPC/JAN commercial product barcode, Code 39 barcode, Code 128 barcode, Interleave 2/5 barcode, or Code 93 barcode. The two-dimensional barcode signal can be a PDF 417 barcode or QR Code barcode.

Further, the display screen 12 of the barcode display device 1 can be a LCD (liquid crystal display) or TFT-LCD (Thin film transistor LCD).

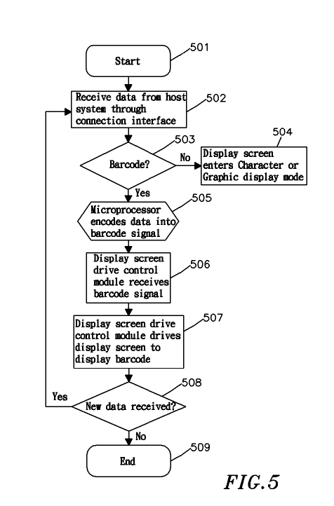

Referring to FIG. 5, the operation of the barcode display device 1 comprises the steps of:

(501) starting;

(502) connecting the connection interface to the host system to receive data from the host system;

(503) the microprocessor judging if the data is a barcode? and then proceeding with step (505) if the data is a barcode, or step (504) if the data is not a barcode;

(504) the display screen displaying characters or graphics to finish the display procedure;

(505) the microprocessor encoding the data into a corresponding barcode signal;

(506) the display drive control module receiving the barcode signal;

(507) the display drive control module driving the display screen to display the barcode signal;

(508) the microprocessor judging if there is any new data? and then proceeding with step (509) if no new data is received, or returning to step (502) if a new data is received;

(509) ending.

As indicated above, the invention provides a barcode display device, which has the following features.

1. The microprocessor converts the data of the host system into a corresponding barcode signal for display on the display screen of the barcode display device, so that the displayed barcode can be scanned by the barcode reader and stored in the memory of the barcode reader, eliminating the chance of altering the storage data of the host system by the user that may cause a big company loss.

2. The invention fully utilizes advantage of the characteristic of small memory space occupation of a barcode signal by converting a big amount of host system data into barcode data for storage in the memory of the barcode reader, for enabling the storage barcode data to be further transmitted to the processing unit that is capable of returning the barcode data into the original data format. This method eliminates the complicated transcription work to improve the working efficiency, allowing the user to collect data from multiple host systems rapidly.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A barcode display device comprising:
a connection interface connectable to a host system to receive storage data from said host system;
a microprocessor electrically connected to said connection interface to receive data from said host system to which said connection interfaced is connected and to convert the received data into a barcode signal;
a display screen; and
a display drive control module electrically connected to said microprocessor and adapted to receive outputted barcode signal from said microprocessor and to drive said display screen to display the barcode signal.

2. The barcode display device as claimed in claim 1, wherein said connection interface is a two-wire serial bus interface.

3. The barcode display device as claimed in claim 1, wherein said connection interface is a MPU interface.

4. The barcode display device as claimed in claim 1, wherein said connection interface is a UART interface.

5. The barcode display device as claimed in claim 1, wherein said microprocessor is adapted to convert data into an one-dimensional barcode signal, which is one of the barcodes including EAN/UPC/JAN commercial product barcode, Code 39 barcode, Code 128 barcode, Interleave 2/5 barcode, and Code 93 barcode.

6. The barcode display device as claimed in claim 1, wherein said microprocessor is adapted to convert data into a two-dimensional barcode signal, which is one of the barcodes of PDF 417 barcode and QR Code barcode.

7. The barcode display device as claimed in claim 1, wherein said microprocessor is adapted to convert data into a self-defined barcode signal.

8. The barcode display device as claimed in claim 1, wherein said display screen further provides a character display mode and a graphic display mode.

9. The barcode display device as claimed in claim 1, wherein said display screen is a LCD (liquid crystal display).

10. The barcode display device as claimed in claim 1, wherein said display screen is a TFT-LCD (Thin film transistor LCD).

11. The barcode display device as claimed in claim 1, further comprising a timer electrically connected to said microprocessor for measuring a time interval and signaling the end of the time interval measured.

12. The barcode display device as claimed in claim 1, further comprising a power supply device for providing the barcode display device with the necessary working voltage.

13. A barcode display device operation procedure used in a barcode display device, which comprises a connection interface connectable to a host system to receive storage data from said host system, a microprocessor electrically connected to said connection interface to receive data from said host system to which said connection interfaced is connected and to convert said received data into a barcode signal, a display screen, and a display drive control module electrically connected to said microprocessor and adapted to receive outputted barcode signal from said microprocessor and to drive said display screen to display said barcode signal, said barcode display device operation procedure comprising the steps of:
(A) starting;
(B) connecting said connection interface of said barcode display device to said host system to receive data from said host system;
(C) enabling said microprocessor to judge if said received data is a barcode? and then proceeding with follow step (D) if the data is a barcode;
(D) driving said microprocessor to encode said received data into a corresponding barcode signal;
(E) driving said display drive control module to receive said barcode signal from said microprocessor;
(F) enabling said display drive control module to drive said display screen to display said barcode signal received from said microprocessor;
(G) enabling said microprocessor to judge if any new input data? and then proceeding with follow step (H) if no new data is received; and
(H) ending the procedure.

14. The barcode display device operation procedure as clamed in claim 13, wherein said barcode display device further comprises a timer; the barcode display device operation procedure further comprising a sub-step of driving said display screen to display characters/graphics if the data judged by said microprocessor during step (C) is not a barcode.

15. The barcode display device operation procedure as clamed in claim 13, further comprising a sub-step of returning to step (B) if a new data is received during step (G).
